(19) United States
(12) Patent Application Publication
(10) Pub. No.: US 2026/0274065 A1
(43) Pub. Date: Sep. 17, 2026

(54) Electrically Operated Fueling or Charging Flap System With an Emergency Opening Capability for a Vehicle, Emergency Opening Method, and Vehicle

(71) Applicant: Bayerische Motoren Werke Aktiengesellschaft, Muenchen (DE)

(72) Inventor: Thomas ROTH, Eching (DE)

(21) Appl. No.: 18/872,406

(22) PCT Filed: Oct. 13, 2023
(86) PCT No.: PCT/EP2023/078464

§ 371 Date: Dec. 6, 2024

(30) Foreign Application Priority Data
Oct. 27, 2022 (DE) 10 2022 128 434.4

(51) Int. Cl. B60K 15/05; B60L 53/16; E05B 83/34; E05F 15/60

(52) U.S. Cl. CPC B60K 15/05; B60L 53/16; E05B 83/34; E05F 15/60; B60K 2015/0515; B60K 2015/0584; E05Y 2900/534

(57) ABSTRACT

An electrically operated fueling and/or charging flap system for a vehicle has a movable closure flap which can be moved between a closed position and an open position in order to connect an external connecting part to the opened flap system in order to electrically charge and/or fuel the vehicle and reclose the flap system after the charging or fueling process. An emergency opening tool with an elongated design for manually opening the closure flap in the event of a malfunction is designed to be inserted into a joint gap between the body element of the vehicle and the closure flap and subsequently pull open and/or lever open the closure flap. In a method for an emergency opening process of the fueling or charging flap system, an end section of the emergency opening tool is inserted into the joint gap between the body element and the closure flap, and the closure flap is thus pulled open or levered open.

### BACKGROUND AND SUMMARY

The invention relates to an electrically operated fueling and/or charging flap system for a vehicle, to a method for emergency opening of an electrically operated fueling and/or charging flap system, and to a vehicle. The fueling and/or charging flap system is also called a flap system here.

The invention is suitable, in particular, for use in electrically driven vehicles, in the case of which an external electrical power source such as, for example, a charging station is connected to the vehicle, in order to charge it with electricity as an energy source which is stored in an electrical store of the vehicle.

The invention can also be applied, however, in the case of vehicles with internal combustion engines, in the case of which, for example, a fuel is supplied to the vehicle as the energy source at a gas station. The invention can also be used for hybrid vehicles, in the case of which an external power source is connected to the vehicle, in order to charge it with electrical power and/or to fill it with a fuel.

Flap systems of this type as a rule have a pivotable charging or closure flap which is driven by way of an electric motor. In order to fill the vehicle with an energy source such as, for example, electrical power or a different type of fuel for driving the vehicle motor, the charging or closure flap is opened, and is closed again after filling, in order to seal the connector or filling unit lying behind it to the outside and to protect it against effects from the outside.

An active locking of the charging flap is necessary in order to fulfill the requirements of the seal of the charging flap, charging sockets, joint and joint appearance, and the necessary locking force during driving operation and also to protect against improper use.

One problem consists in that, in the case of a technical defect, for example in the electric motor of the flap system or in the area of the flap controller, the charging or closure flap can no longer be opened and therefore the vehicle can no longer be charged or fueled. An onward journey is often no longer possible as a result.

Known approaches for solving this problem consist of, in the case of a defect, bringing about the opening of the charging flap via an air cushion which is plugged into the joint gap next to the charging flap and is inflated. In the case of a suddenly occurring defect, however, this can scarcely be brought about or can be brought about only with difficulty for a vehicle user, since corresponding apparatuses for opening the charging flap in the case of a defect require specialized skill.

In the case of a defect, it is therefore necessary in most cases to request technical service or mobile maintenance, in order to open the closure flap and to charge the vehicle for the onward journey. This requires a large amount of time and high costs.

It is an object of the invention to provide an electrically operated charging or fueling flap system and to provide a method, in the case of which the fueling or charging flap can be opened in a simple and rapid way by way of the user in the case of a defect.

In order to achieve the object, the invention according to a first aspect provides an electrically operated fueling and/or charging flap system for fastening in a vehicle body element of a vehicle, comprising: a movable closure flap which can be moved to and fro between a closed position and an open position, in order to connect an external connecting part for electrically charging and/or for fueling the vehicle to the open fueling and/or charging flap system and to subsequently close the fueling and/or charging flap system again; and an elongate emergency opening tool for manually opening the closure flap in the case of a malfunction, which emergency opening tool is configured for plugging into a joint gap between the vehicle body element of the vehicle and the closure flap in its closed position and to subsequently pull and/or pry open the closure flap.

As a result, the charging or fueling flap can be pulled open and the vehicle can be charged. A complicated emergency actuation with all the known disadvantages is avoided. Therefore, a customer solution is produced, with the result that no service is necessary to open the flap such as, for example, by way of a mobile service unit which has to drive to the vehicle.

The emergency opening tool is preferably of elongate configuration.

The emergency opening tool preferably comprises a front end portion, the thickness of which is smaller than the width of the joint gap.

The emergency opening tool preferably comprises an angled-away front end, in order to engage behind the closure flap when plugged into the joint gap, with the result that the closure flap can be opened by subsequently pulling on the emergency opening tool.

The fueling/charging flap system advantageously comprises a coupling element, in order to decouple the closure flap, during pulling or prying open, from an electrically operated drive element for driving the closure flap.

The fueling/charging flap system preferably comprises a locking device for locking the closure flap in its closed position, comprising a movable locking element which is held in its locking position by means of a positively locking connection by way of an elastic element.

In particular, the locking element is shaped in such a way that the positively locking connection is released by way of the closure flap being pulled or pried open.

For example, pulling and/or prying open takes place counter to a force which is exerted on the locking element by way of the elastic element.

The elastic element is preferably configured as a spring, in particular as a compression spring.

The movable locking element is advantageously configured as a pin.

The movable locking element can be locked and/or unlocked by way of interaction with a surface, running obliquely with respect to the moving direction of this locking element, of a ramp.

After its use, for example, the emergency opening tool can be stowed in the trunk again.

For example, the fueling/charging flap system comprises a holding element which is configured for fastening to a vehicle body element, in particular to a side frame of the vehicle. For example, the holding element is formed by way of a charging socket or charging recess and/or by way of a fueling recess.

In particular, the holding element is configured to receive or to hold a connector element which is configured for connecting an external connecting part, in order to feed electrical energy or fuel to the vehicle.

For example, the connector element is configured as a charging socket. It can also, however, be configured as a filler pipe or connector for connecting a fuel supply for supplying a combustion fuel.

In particular, the fueling/charging flap system comprises an electric motor for driving the closure flap, in order for it to pass into the open or closed position.

In accordance with a second aspect of the invention, a method for emergency opening of an electrically operated fueling and/or charging flap system is provided, wherein the flap system is fastened in a vehicle body element of the vehicle and comprises a closure flap which can be moved to and fro by means of a between a closed position and an open position, comprising the steps:
a) providing an emergency opening tool of elongate configuration;
b) plugging an end portion of the emergency opening tool into a joint gap between the vehicle body element of the vehicle and the closure flap while it is situated in the closed position; and
c) pulling and/or prying open the closure flap by means of the emergency opening tool which is plugged into the joint gap.

During or after being plugged into the joint gap, an end portion of the emergency opening tool preferably acts on the rear side of the closure flap.

A force is advantageously exerted in the opening direction on the rear side of the closure flap by way of the end portion.

For example, by way of being pulled or pried open, the closure flap is decoupled from an electrically operated drive element for driving the closure flap.

In particular, by way of being pulled or pried open, the closure flap is released from a positively locking action counter to an elastic force.

In accordance with a further aspect of the invention, a vehicle is provided which comprises a fueling or charging flap system according to the invention and/or can be opened by way of a method according to the invention.

Advantages and details which are disclosed above and also in the following text in conjunction with the flap system according to the invention also apply to the method according to the invention, and vice versa.

Features which are described or shown in different embodiments and exemplary embodiments are intended to be understood such that they can be combined among one another unless something to the contrary is described or a combination of this type is obviously impossible.

In the following text, one preferred exemplary embodiment of the invention will be explained in greater detail on the basis of drawings.

### BRIEF DESCRIPTION OF THE DRAWINGS

FIG. 1 shows an electrically operated fueling or charging flap system according to a first preferred embodiment of the invention which is mounted in a vehicle while it is being emergency opened, as a perspective view obliquely from the outside.

FIG. 2 shows the flap system shown in FIG. 1 in an open state, in a perspective view of its front side.

FIG. 3 shows a part (shown on an enlarged scale) of the electrically operable fueling or charging flap system according to FIG. 1, as a perspective sectional illustration during a first phase of an emergency opening operation.

FIG. 4 shows an illustration of the flap system which is similar to that of FIG. 1, but during a second phase of the emergency opening operation.

FIG. 5 shows an illustration of the flap system which is similar to that of FIGS. 1 and 4, but during a third phase of the emergency opening operation.

FIG. 6 shows an electrically operated fueling or charging flap system in accordance with a second preferred embodiment of the invention which is mounted in a vehicle, while it is being emergency opened.

FIG. 7 shows an electrically operated fueling or charging flap system in accordance with one particularly preferred embodiment of the invention which comprises a locking device, in a partially perspective sectional illustration.

### DETAILED DESCRIPTION OF THE DRAWINGS

In the figures, elements which are identical or correspond to one another are each labeled using the same designations and are therefore not described again if this does not appear to be expedient. The disclosures contained in the entire description can be transferred mutatis mutandis to parts with identical designations or identical component names.

The terms “front”, “rear”, etc. relate to the mounted state of the flap system in the vehicle, as viewed from the outer side of the vehicle toward the vehicle interior. They can also relate to the flap system itself, as viewed from its front side or outer side in the direction of its rear side or inner side and also beyond this.

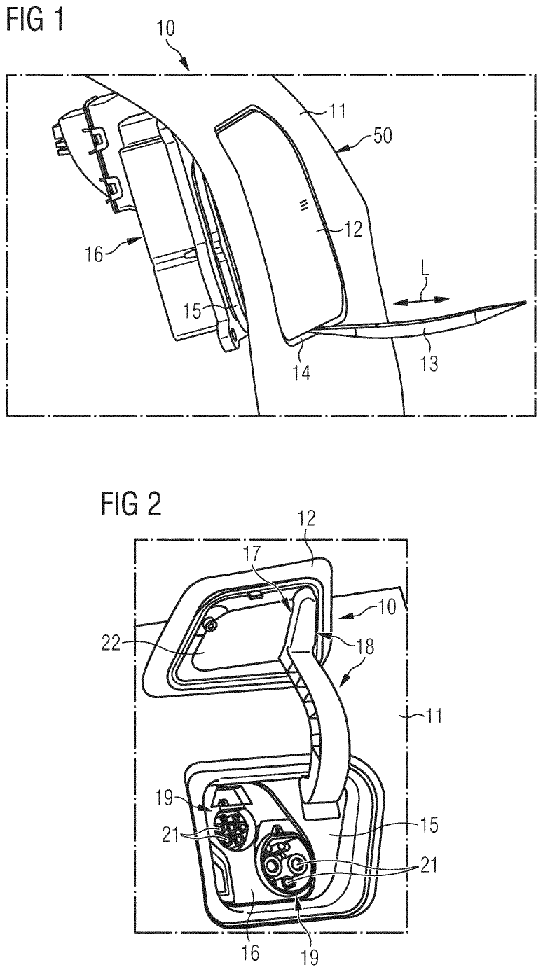

FIGS. 1 and 2 show an electrically operated fueling and/or charging flap system 10 in accordance with a first preferred embodiment of the invention which is configured as a charging flap system for fastening in a vehicle body element 11 of a vehicle 50, in order to supply electrical energy to the vehicle in order to drive it. The vehicle body part 11 is, for example, the side frame of the vehicle 50 or a part thereof.

The charging flap system 10 is also called a flap system. It comprises a movable closure flap or flap 12 which can be moved to and fro between a closed position (see FIG. 1) and an open position (see FIG. 2). As a result, an external connecting part (not shown here) for electrically charging the vehicle can be connected to the fueling and/or charging flap system 10, and subsequently the charging flap system 10 can be closed again, as shown in FIG. 1.

Furthermore, the charging flap system comprises an emergency opening tool 13 which is elongate or extends in its longitudinal direction L and is configured to manually open the closure flap 12 in the case of a malfunction. The emergency opening tool or opening tool 13 is configured in such a way that it can be plugged into a joint gap 14 between the vehicle body element or side frame 11 and the closure flap 12, or can be introduced with a part portion when the flap 12 is situated in its closed position, as shown in FIG. 1.

Furthermore, the emergency opening tool 13 is configured in such a way that the closure flap 12 can be pulled and/or pried open manually by way of the opening tool 13 after the latter has been plugged into the joint gap 14.

In accordance with the preferred embodiment which is shown here, the flap system 10 comprises a holding element in the form of a charging bay 15 which, for example, can also be called a charging recess and is configured for fastening in the side frame element 11. Furthermore, the holding element 15 is shaped or configured in such a way that it receives or holds a connector element 16 which is configured as a charging socket in this example.

The connector element or the charging socket 16 is configured to connect an external connecting part (which is not shown in the figures) to it, in order to supply electrical energy to the vehicle 50 in order to drive it. The external connecting part (not shown here) is, for example, a charging plug of an external electrical charging station.

In the embodiment which is described here, the flap system 10 is configured as a charging flap system, in order to supply electrical energy to the vehicle.

In other embodiments, the flap system 10 is configured as a fueling flap system, in order to supply a fuel such as, for example, gasoline, diesel or gas to the vehicle in order to drive the vehicle. In these cases, the connector element 16 is configured, for example, as a filler neck, in order, for example, to connect a filling nozzle or a pump nozzle of an external gasoline or fueling pump to it. The flap or cover flap 12 is also called a fueling flap here. In the case of a fueling flap system 10, the holding element 15 is configured, for example, as a fueling recess or as a recess body.

In order to drive the closure or cover flap 12, the flap system 10 comprises an electric motor which is not visible in the figures.

The emergency opening tool 13 of elongate configuration serves to open the flap 12 in the case of a technical defect which can have different causes such as, for example, a malfunction of the electric motor for driving the flap 12, or a fault or software fault in the corresponding control unit.

As shown in FIG. 2, the flap 12 is fastened to an outer end 17 of a hinge arm 18. The hinge arm 18 is mounted pivotably on the holding element or charging bay 15, with the result that it is pivoted out of the charging bay 15 in a motor-operated manner when the electric motor is caused to do this by way of a control unit.

The connector element which is configured here as a charging socket 16 comprises plug elements or plug faces 19 with a plurality of electrical contact elements 21 which are configured for electrical contacting with corresponding contact elements of an external charging plug or other electrical connecting part.

The flap 12 is fastened to a flap fastening element 22 which is configured at the outer end 17 of the hinge arm 18 and is of plate-like design.

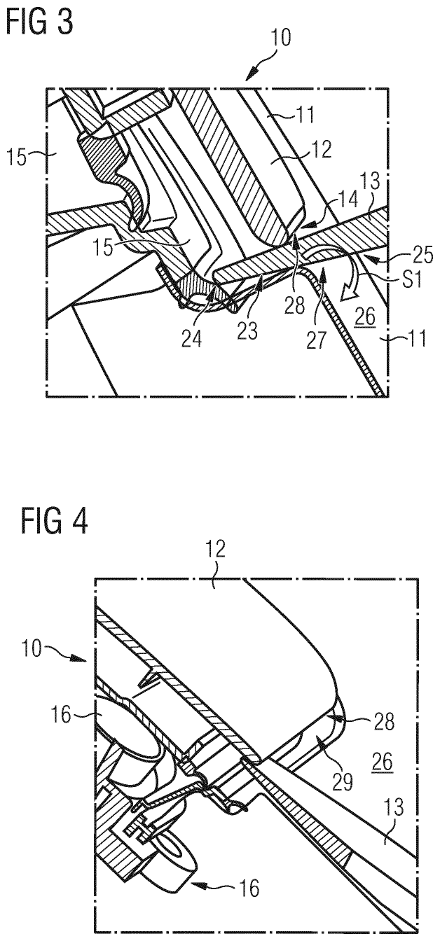

FIG. 3 shows an enlarged illustration of a front end portion 23 of the opening tool 13 after it has been plugged into the joint gap 14 between the flap 12 and the vehicle body element 11. The front end portion 23 has a thickness which is smaller than the width of the joint gap 14 when the flap 12 is closed.

The opening tool 13 is pointed or tapered in the direction of its front end 24, in order to facilitate plugging or introducing it into the joint gap 14 when the flap 12 is situated in its closed position.

The opening tool 13 is configured in such a way that, after its front end portion 23 is plugged in or introduced, it can be used as a lever, in order to pry open the flap 12 with the end portion 23 which is then situated below or behind the flap 12. Here, that portion 25 of the opening tool 13 which protrudes above the flap 12 is pressed away from the flap 12 in the direction of a vehicle body region 26 which lies opposite the flap 12, as a result of which the opening tool 13 carries out a pivoting movement S1. Here, the pivot axis is formed by way of an edge portion 27 of the vehicle body region 26 which, in the region of the joint gap 14, lies opposite an edge portion 28 of the flap 12.

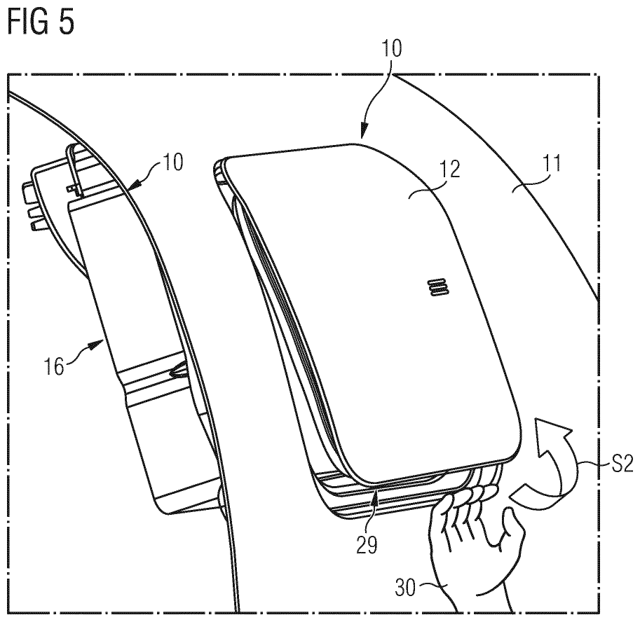

As shown in FIG. 4, the flap 12 is open a little after being pried open by way of the opening tool 13. As a result, its edge portion 28 in the region of the opening tool 13 which is plugged into the joint gap 14 is then situated above the vehicle body region 26 which lies opposite the edge 28.

In this state, an opening 29 is configured between the edge 28 of the flap 12 and the vehicle body region 26, into which opening 29 a user of the vehicle can reach with one or with several fingers of their hand 30 and, as a result, can pull the flap 12 outward, as shown in FIG. 5. Here, a pivoting movement S2 of the flap 12 takes place about its pivoting axis which is formed by way of a movable fastening of the hinge arm 18 in the interior space of the vehicle.

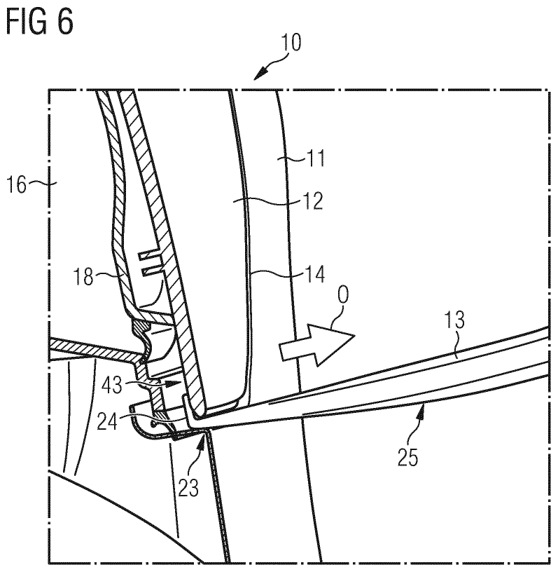

FIG. 6 shows a further embodiment of the fueling or charging flap system 10, wherein the opening tool 13 has an angled-away front end 24 in the region of its end portion 23. Here, the front end 24 is oriented substantially at a right angle with respect to the remaining region of the opening tool 23.

Here too, the opening tool 13 is configured to be pointed at least in its front end portion 23 or to taper toward the front end 24. As a result, the introduction of the front end portion 23 of the opening tool 13 into the joint gap 14 is facilitated.

After the opening tool 13 is plugged or introduced into the joint gap 14, its front end 24 engages behind the flap 12 on its rear side 43, with the result that this flap is moved and opened by way of pulling of the opening tool 13 in the opening direction O. Here, it is pivoted out together with the hinge arm 18, to which it is fastened by way of the flap fastening element 22, in order finally to pass into its open position (see FIG. 2).

Depending on the embodiment, the drive of the flap 12 can be configured in such a way that, during the above-described opening operation with the aid of the opening tool 13, the self-locking action of the electric motor which is provided to drive the flap is overcome, with the result that the flap 12 can be opened manually by pulling or prying open by means of the opening tool 13.

As an alternative or in addition to this, the flap system 10 comprises a coupling element which is configured for decoupling the flap 12 or the hinge arm 18 from the electric motor.

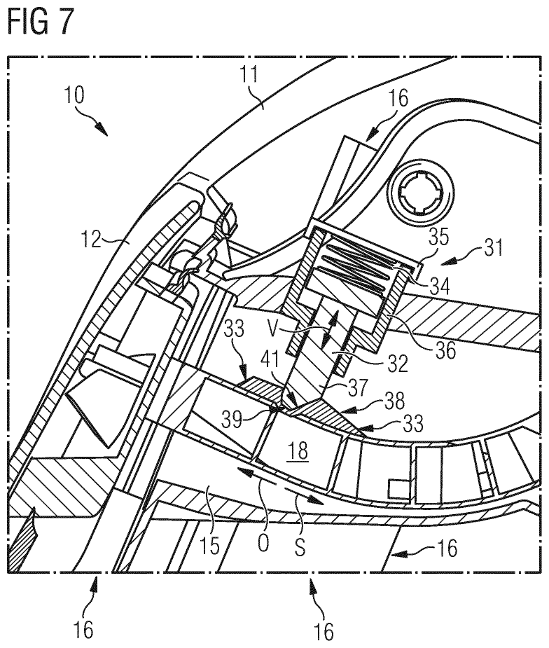

One particularly preferred embodiment of the flap system 10 is shown in FIG. 7. The flap system 10 additionally comprises a locking device 31 for locking the flap 12 when it is situated in its closed position.

The locking device 31 comprises a locking element 32 of elongate configuration which is designed as a pin. The pin 32 is mounted such that it can be moved in its longitudinal direction V, with the result that it can be moved in the direction of a locking portion 33 arranged on the hinge arm 18 and likewise in the opposite direction.

The pin 32 is preloaded in the direction of the locking portion 33 by means of an elastic element which is configured as a spring or compression spring 34. For this purpose, the compression spring 34 is supported with one end on a cap element 35 which is configured as a covering cap and is fastened to the holding element or charging bay 15. With its end which lies opposite the covering cap 35, the compression spring 34 loads the pin 32 elastically against the locking portion 33 of the hinge arm 18.

A housing 36 of the locking device 31 surrounds the compression spring 34 and a part of the cylindrically shaped pin 32, with the result that the latter is held and guided during its movement.

At its front end 37, the pin 32 forms a positively locking connection to the locking portion 33 in the locked state by its front end 37 engaging into a corresponding recess 39 of the locking portion 33.

The locking portion 33 forms a ramp for locking and unlocking the pin 32.

The locking portion or the ramp 33 comprises a surface 38 which runs obliquely with respect to the movement direction or longitudinal direction V of the pin 32. During closing of the flap 12, the hinge arm 18 together with the ramp 33 which is configured on it moves in the closing direction S, that is to say in the direction of the vehicle interior or to the right in FIG. 7. Here, the pin 32 is pressed with the aid of the oblique surface 38 of the ramp 33 in the direction of the compression spring 34 counter to its spring force, that is to say upward in FIG. 7.

As soon as the flap 12 is completely closed, the front end 37 of the pin 32 reaches the recess 39 in the locking portion 33 and latches therein on account of the force which is exerted by way of the spring 34, wherein the positively locking connection is formed between the pin 32 and the locking portion 33.

A further surface 41 which runs obliquely with respect to the movement direction V of the pin 32 is arranged on the opposite side of the ramp 33, with the result that, during pulling or prying open of the flap 12 and the associated movement of the hinge arm 18, the pin 32 is pushed away from the locking portion 33 in the opening direction O, that is to say to the left in FIG. 7. Here, the pin 32 slides with its front end 37 on the surface 41 of the ramp 33 and, as a result, is moved counter to the spring force which is exerted on the pin 32 by way of the compression spring 34. As a result of the movement of the pin 32 counter to the spring force, it is released from the recess 39, that is to say the positively locking connection is released.

During further opening of the flap 12, the front end 37 of the pin 32 again slides along the ramp 38 in the direction of the hinge arm 18 on account of the spring force which is exerted by way of the compression spring 34. It remains there until the flap 12 is moved into its closed position again.

In the following text, one preferred exemplary embodiment of the method for emergency opening of an electrically operated fueling and/or charging flap system 10 will be described on the basis of the figures. Here, for example, the fueling or charging flap system 10 is used as described above.

First of all, in a first step (a), the emergency opening tool 13 of elongate configuration is provided. It is arranged, for example, in the trunk of a vehicle, with the result that it can be easily removed and can be used to open the flap system 10 in an emergency situation, that is to say if electrical opening of the flap 12 is not possible on account of a defect.

Subsequently, in a further step (b), the front end portion 23 of the opening tool 13 is plugged or introduced manually by way of a user of the vehicle into the joint gap 14 which is configured between the vehicle body element 11 of the vehicle 50 and the closure flap or flap 12 of the flap system 10 while the latter is situated in its closed position (see FIGS. 1 and 3).

Afterward, in a step (c), the flap 12 is pried and/or pulled open by means of the emergency opening tool 13 which is plugged manually into the joint gap 14. To this end, after being plugged into the joint gap, the emergency opening tool 13 is turned toward the bottom.

By way of fingers reaching behind the charging flap 12, the charging flap 12 can then be manually opened completely (see FIGS. 4-6).

In step (c), after being introduced into the joint gap 14, an optionally provided angled-away front end 24 of the emergency opening tool 13 preferably acts on the rear side 43 of the flap 12, and a pulling force is exerted in the opening direction O on the rear side 43 of the flap 12 by way of the angled-away end or the end portion 24.

To this end, first of all the angled-away end portion 24 is plugged into the joint gap 14 between the charging flap 12 and the side frame 11. Subsequently, the opening tool 13 is pivoted by approximately 90° in the manner of a lever with the aid of its portion which protrudes out of the joint gap 14. The emergency opening tool 13 is then pulled in the opening direction O of the flap 12.

In one variant of the method, the flap 12 is decoupled, by being pulled or pried open, from an electrically operated drive element for driving the flap 12, for example an electric motor. This is advantageous, in particular, when the self-locking action of the motor is too strong or the motor prevents the flap 12 from being pried and/or pulled open.

For further details with respect to the emergency opening tool 13 being plugged into the joint gap 14 and with respect to the flap 12 subsequently being pulled and/or pried open, reference is made to FIGS. 1-6 and the associated description.

In a further variant of the method, in step (c), a locking action of the kinematics system is released and the flap 12 opens. Here, the flap 12 is released, by way of being pulled or pried open, from a positively locking action counter to the elastic force which is exerted by way of the compression spring 34 on the pin 32. Reference is made to FIG. 7 and the associated description for further details in this regard.

### LIST OF DESIGNATIONS

10 Fueling and/or charging flap system, or flap system
11 Vehicle body element/side frame
12 Flap or closure flap, fueling or charging flap
13 Opening or emergency opening tool
14 Joint gap
15 Holding element or charging bay, charging recess
16 Connector element or charging socket, filler neck
17 Outer end
18 Hinge arm
19 Plug elements or plug faces
21 Contact elements
22 Flap fastening element
23 Front end portion
24 Angled-away front end/angled-away end portion
25 Protruding portion
26 Vehicle body region
27 Edge portion of the vehicle body region
28 Edge or edge portion of the flap
29 Opening
30 Hand
31 Locking device
32 Locking element or pin
33 Locking portion or ramp
34 Elastic element or spring or compression spring
35 Cap element or covering cap
36 Housing
37 Front end of the locking element
38 Oblique surface of the ramp
39 Recess
41 Oblique surface of the ramp
43 Rear side
50 Vehicle
S1, S2 Pivoting movement
O Opening direction
S Closing direction
V Longitudinal direction of the locking element

1.-10. (canceled)

11. An electrically operated fueling and/or charging flap system for fastening in a vehicle body element of a vehicle, comprising:
a movable closure flap that is movable to and fro between a closed position and an open position to allow for connecting an external connecting part to an opened flap system for electrically charging and/or for fueling the vehicle, and to close the flap system after the charging or fueling; and
an emergency opening tool of elongate configuration for manually opening the closure flap in an event of a malfunction, which emergency opening tool is configured for plugging into a joint gap between the vehicle body element of the vehicle and the closure flap in its closed position and to subsequently pull and/or pry open the closure flap.

12. The fueling or charging flap system according to claim 11, wherein
the emergency opening tool of elongate configuration comprises a front end portion, a thickness of which is smaller than a width of the joint gap.

13. The fueling or charging flap system according to claim 11, wherein
the emergency opening tool comprises an angled-away front end, in order to engage behind the closure flap when plugged into the joint gap, so that the closure flap is openable by subsequently pulling on the emergency opening tool.

14. The fueling or charging flap system according to claim 11, further comprising:
a coupling element to decouple the closure flap, during pulling or prying open, from an electrically operated drive element for driving the closure flap.

15. The fueling or charging flap system according to claim 11, further comprising:
a lock that locks the closure flap in its closed position,
the lock comprising a movable locking element which is held in its locking position via a positively locking connection by way of an elastic element, wherein the locking element is shaped such that the positively locking connection is released by way of the closure flap being pulled or pried open.

16. The fueling or charging flap system according to claim 15, wherein
the movable locking element is configured as a pin which is locked and unlocked by way of interaction with a surface, running obliquely with respect to the moving direction of said pin, of a ramp.

17. A method for emergency opening of an electrically operated fueling or charging flap system, wherein the fueling or charging flap system is fastened in a vehicle body element of the vehicle and comprises a closure flap which is movable to and fro between a closed position and an open position, the method comprising the steps of:
a) providing an emergency opening tool of elongate configuration;
b) plugging an end portion of the emergency opening tool into a joint gap between the vehicle body element of the vehicle and the closure flap while the closure flap is situated in the closed position; and
c) pulling and/or prying open the closure flap via the emergency opening tool which is plugged into the joint gap.

18. The method according to claim 17, wherein,
during or after being plugged into the joint gap, an end portion of the emergency opening tool acts on a rear side of the closure flap, and subsequently a force is exerted in the opening direction on the rear side of the closure flap by way of the end portion.

19. The method according to claim 17, wherein, by way of being pulled or pried open, the closure flap is:
(i) decoupled from an electrically operated drive element for driving the closure flap, and/or
(ii) released from a positive locking action counter to an elastic force.

20. A vehicle comprising an electrically operated fueling or charging flap system according to claim 11.
